(19) United States
(12) Patent Application Publication
(10) Pub. No.: US 2011/0084830 A1
(43) Pub. Date: Apr. 14, 2011

(54) ACTIVE EMERGENCY CONTROL SYSTEM BASED ON REAL TIME LOCATION SYSTEM AND SENSOR NETWORK

(75) Inventors: Hee-Jin Kang, Daejeon (KR); Dong-Kon Lee, Daejeon (KR); Jin-Tae Lee, Daejeon (KR)

(73) Assignee: KOREA MARTIME & OCEAN ENIGINEERING RESEARCH INSTITUTE

(21) Appl. No.: 12/996,970

(22) PCT Filed: Jun. 13, 2008
(86) PCT No.: PCT/KR08/03340

§ 371 Date: Dec. 8, 2010

(51) Int. Cl. G08B 25/00

(52) U.S. Cl. 340/524

(57) ABSTRACT

Disclosed is an active emergency control system capable of guiding passengers to a safe evacuation route from an accident occurring area, controlling access to the accident area, and rescuing the isolated or trapped passengers using a real time location recognition and sensor network technology when an accident such as a fire, flooding, explosion, collapse or overturning occurs in a large structure like a cruise ship having complicated interiors. The inventive system is a core technology that is capable of preventing a situation leading to a large scale disaster due to the lack of recognition of proper evacuation route and evacuation procedure thereof in case of an accident, and is then expected to contribute to the control of an emergency situation and protect and save the lives of people. Further, the present invention offers advantages that it can be easily reduced into practice by establishing a system and its application through the incorporation with a conventional emergency control system as well as adopting commercialized technology already in use.

### TECHNICAL FIELD

The present invention relates to an emergency control system, and more particularly, to an active emergency control system based on a real time location recognition system and sensor network that is capable of safely and promptly evacuating people who lack the understanding of structures, when an accident such as a fire, flooding, explosion, collapse or overturning occurs in a large structure like a cruise ship having complicated interiors with numerous attendants and passengers.

### BACKGROUND ART

In the event that there arises an accident such as a fire, flooding, explosion, collapse or overturning in a large structure like a cruise ship which has complicated interiors and numerous attendants and passengers staying therein, generally conventional technologies have used certain devices, as mentioned below, to help people evacuate from the accident area: an exit guiding light for indicating an evacuation passageway, speaker for rescue broadcasting, transceiver for crew members or the like. When an accident actually occurs, the exit guiding light indicates only the location of the passageway to flee, but cannot advise a safe evacuation route to take. Using a speaker for rescue broadcasting is then dangerous because it may cause a disorder or unpredictable passenger activity in an emergency situation. Further, the transceiver for the crew members has limitations in use within a large steel structure like a huge cruise ship, and is also limited in the amount of information transmitted therewith.

### DISCLOSURE

### Technical Problem

In view of the above-noted drawbacks and other problems inherent in the prior art, it is an object of the present invention to provide an active emergency control system that is capable of guiding passengers to a safe evacuation route from an accident occurring area, controlling access to the accident area, and efficiently rescuing the isolated or trapped passengers using a real time location recognition and sensor network technology in case of an accident such as a fire, flooding, explosion, collapse or overturning in a large structure like a cruise ship having complicated interiors.

### TECHNICAL SOLUTION

In order to accomplish the above-mentioned objects, the present invention provides an active emergency control system based on a real time location recognition system and sensor network.

### ADVANTAGEOUS EFFECTS

According to the present invention, the inventive system is a core technology capable of preventing large scale disasters due to the lack of understanding on a proper evacuation route and evacuation procedure thereof when an accident occurs in a large structure like a cruise ship having complicated interiors with numerous attendants and passengers, and the inventive system is then expected to contribute to the control of an emergency situation and protect and save the lives of people. Further, the present invention offers advantages that it can be easily reduced into practice by establishing a system and its application since it can be incorporated with conventional emergency control systems as well as adopting commercialized technologies already in use.

### DESCRIPTION OF DRAWINGS

The above and other objects, features and advantages of the present invention will be more apparent from the following detailed description taken in conjunction with the accompanying drawings, in which:

FIG. 1 is a drawing schematically showing a configuration of the active emergency control system based on a real time location recognition system and sensor network in accordance with the present invention;

FIG. 2 is a drawing showing exemplary displays of the active exit guiding light in accordance with the present invention; and

FIG. 3 is a flow chart illustrating an operational principle of the active emergency control system based on a real time location recognition system and sensor network in accordance with the present invention.

### MODE FOR INVENTION

Hereinafter, a preferred embodiment of the present invention will be described in detail with reference to the accompanying drawings.

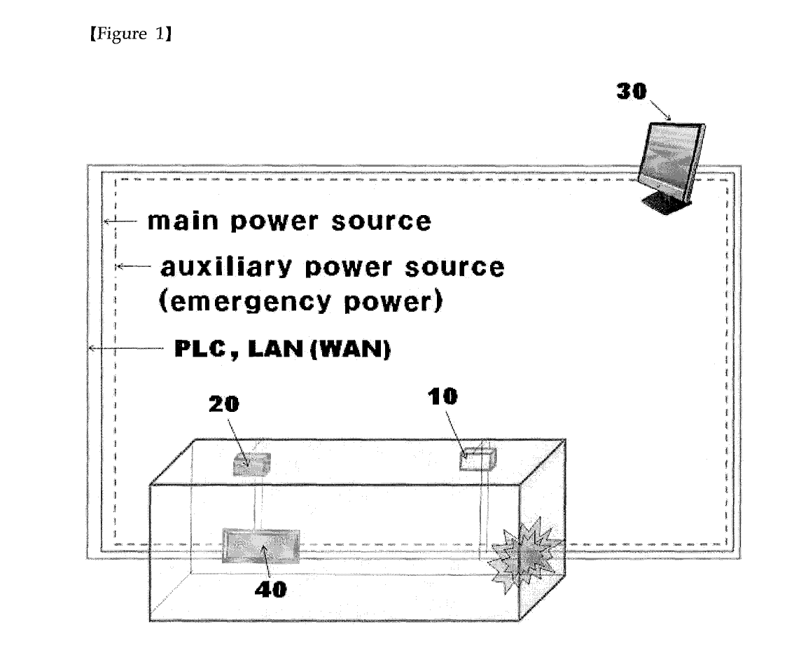

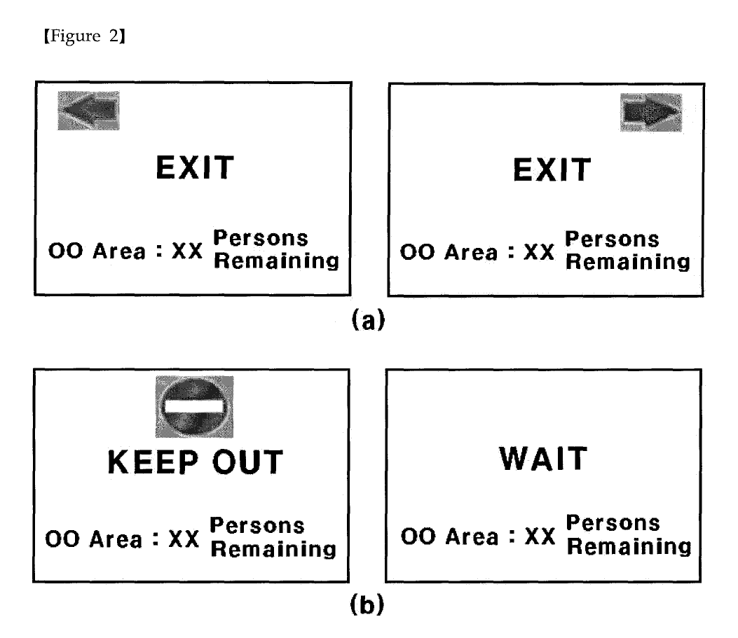

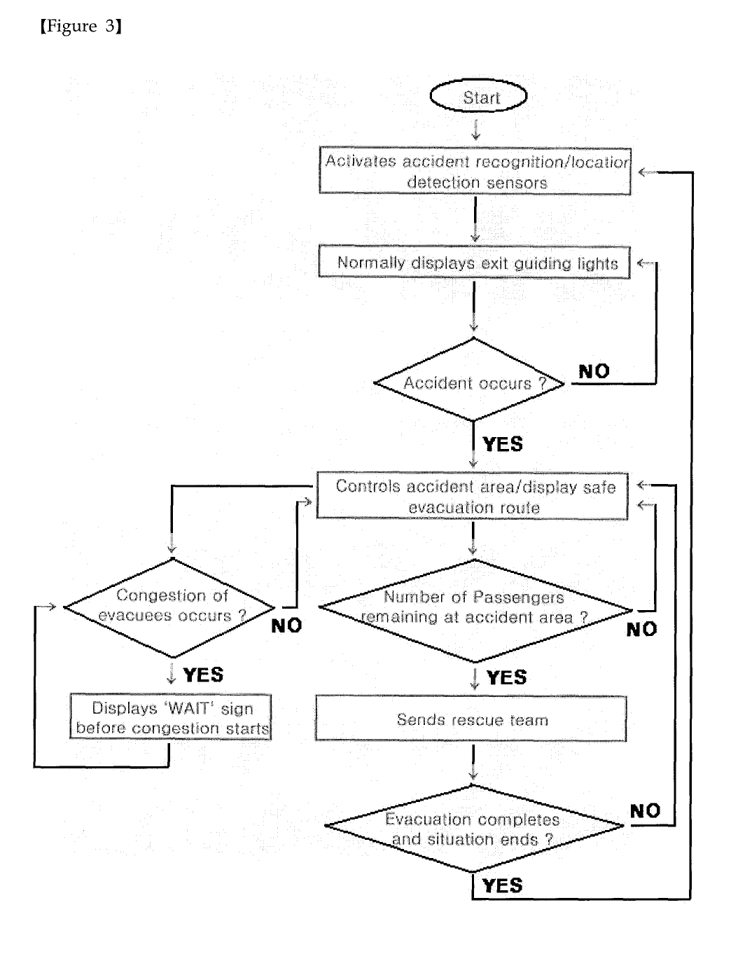

FIG. 1 is a drawing schematically showing a configuration of the active emergency control system based on a real time location recognition system and sensor network in accordance with the present invention, and FIG. 2 is a drawing showing exemplary displays of the active exit guiding light in accordance with the present invention. FIG. 3 is a flow chart illustrating an operational principle of the active emergency control system based on a real time location recognition system and sensor network in accordance with the present invention.

An active emergency control system based on a real time location recognition system and sensor network in accordance with the present invention is proposed to prevent a large scale disaster in advance by guiding passengers quickly to recognize a proper evacuation route and evacuation procedure thereof when an accident occurs in a large structure like a cruise ship having complicated interiors. The system includes an accident recognition part 10, a location detection part 20, a central control unit 30, and an active exit guiding light 40.

The accident recognition part 10 serves to realize the occurrence of the accident and transmit information regarding the accident to the central control unit 30. The accident recognition part 10 consists of an accident measurement part and an accident evaluation part.

The accident measurement part is an assembly of a plurality of sensors each positioned at various places of a large structure like a cruise ship having complicated interiors, which measures temperature, humidity and vibration thereof. In this case, a temperature sensor measures temperature, a humidity sensor measures humidity, and a vibration sensor measures the vibration throughout the respective locations. In the alternative, it is possible to employ an integrated sensor having all of such functions therein.

It is desirable that relatively more accident measurement parts should be located at the area that is deemed to have a high probability of an accident accordingly, which assists passengers to quickly conceive the occurrence of an accident.

The accident evaluation part refers to a kind of computing device which collects and evaluates data measured at the accident measurement part. If the accident evaluation part detects that an accident occurs, it transmits the relating information about the accident to the central control unit 30. When the accident evaluation part transmits a signal of the occurrence of the accident to the central control unit 30, the inventive active emergency control system based on the real time location recognition and sensor network initiates to perform a passenger evacuation function. A detailed description on that function will be made hereinbelow.

The accident evaluation part assesses whether an accident occurs or not on the basis of the accident occurrence index which is predetermined or programmed in advance. For instance, if the temperature measured increases over a given level, the accident evaluation part decides that a fire, in fact, occurs. If the humidity increases over a particular number, the accident evaluation part decides the occurrence of a flooding. Further, if the vibration changes over a specific range, the accident evaluation part decides that an explosion, collapse or overturning accident has occurred.

When the accident evaluation part transmits the accident-related information to the central control unit 30, it is desirable that information on the location of the accident area and risk factors present in that area should be concurrently provided to the central control unit 30. The reason is that it can help passengers recognize more precisely information regarding the accident situation and then the evacuation measures through the central control unit 30 and the active exit guiding light 40. Detailed description thereof will be made hereinbelow.

The location detection part 20 serves to detect the location of the passengers and their evacuation situation, so that it can transmit the relating information thereof to the central control unit 30.

In that regard, the location detection part 20 detects the location of the passenger at every floor or deck of the cruise ship and its evacuation situation using location recognition technologies such as Zigbee, Radio-Frequency Identification (RFID), Infrared beam, Ultrasonic wave, Radio Frequency (RF), Ultra Wideband (UWB) or the like. The present invention has no limitation on the category of the location recognition technology that can be used for the location detection part 20.

Therefore, the location detection part 20 may include a RFID tag possessed by an individual passenger and a plurality of RFID readers which are designed to recognize the RFID tag and transmit the information of the corresponding RFID tag detected to the central control unit 30. In this case, the RFID readers should be installed at every space where passengers are expected to stay.

The central control unit 30 is able to decide the location of the passengers and their evacuation situation based on the information of the RFID tag, e.g., identification (ID) of the RFID tag, recognized by the RFID reader. In other words, if the number of the different IDs among the RFID tags recognized at the area, where the RFID reader is located, is equal to 30 in total, it means that there are 30 passengers staying in that area. Furthermore, by tracing the transitions at that area where the same RFID has been recognized, it is possible to analyze the evacuation situation of the corresponding passenger therefrom.

In this case, it is preferable that the RFID tag be in the form of a bracelet so that a passenger can wear it around his or her wrist. Hence, the passenger can possess the RFID tag with ease and have no worries about any loss thereof. Furthermore, it is advised that the RFID tag includes some personal information on the possessor such as his or her name, age, sex or the like, which renders it possible to efficiently perform the evacuation or rescue operations on the basis of more accurate information on the passenger in an urgent situation.

In the alternative, the location detection part 20 may employ an infrared sensor or ultrasonic sensor to detect the location of the passengers and their evacuation situation on a real time basis and then transmit the relating information to the central control unit 30.

The central control unit 30 refers to a kind of computing device which plays a role of controlling an active emergency control system based on a real time location recognition system and sensor network. The central control unit 30 displays the accident situation transmitted from the accident recognition part 10, while transferring the evacuation information to the active exit guiding light 40 based on the scenario which is prescribed or programmed by the information on the location of the passenger transmitted from the location detection part 20.

In the central control unit 30, the accident situation transmitted from the accident recognition part 10 is displayed through a console on a real time basis. Preferably, related information on the accident location and risk factors therein may be displayed together with the information on the location of the passengers and their evacuation situation. In this regard, passengers are able to promptly recognize how to take faster and safer evacuation measures on the basis of the information displayed through the console.

The active exit guiding light 40, based on the evacuation information transmitted from the central control unit 30, displays a safe direction to be evacuated, for instance the direction to a safe exit or in a direction away from the accident occurring area, and the number of people still remaining at the accident area. Accordingly, it is possible to prevent passengers from going in a direction which leads to the accident area, and transfer the information about the remaining passengers at the accident area to nearby crew members, thereby facilitating prompt evacuation and rescue operations (referring to FIG. 2(a)).

The active exit guiding light 40 has a function of displaying the sign of [symbol] eep out or [symbol] ait, which makes it possible to efficiently control the evacuees in an urgent and crowded situation, thereby preventing concentration or congestion of the evacuees at a particular area((referring to FIG. 2(b)).

The active exit guiding light 40 can display the evacuation information using visual media consisting of a combination of characters and devices, but it may concurrently use aural media. For example, in the event of an accident, the active exit guiding light 40 promptly generates an alarm to warn the passengers. Further, the active exit guiding light 40 may provide the passengers with information regarding the safe direction of the evacuation depending on an accident situation, or the number of remaining passengers at the accident area through the aural media like voice or sound. By using both visual and aural media together, it is possible to maximize the evacuation efficiency of the passengers in peril.

Meanwhile, the present active emergency control system based on a real time location recognition system and sensor network establishes a stable operating environment using a PLC or LAN (WAN) separately or simultaneously as a telecommunication network.

In this context, a PLC refers to a Power Line Communication, i.e., a telecommunication which transmits data via a power line. With the PLC, it assists to provide a high speed service for transmitting voices or data or using the Internet by hooking up the power line to the outlet in the house, office or ship, which renders it possible to construct a home network in which all the informational devices such as a television, telephone, personal computer or the like can be interconnected thereto.

By using the PLC, it is possible to incorporate a data transmission route into one power line instead of the conventional complicated lines consisting of a cable television network, telephone line, optical communication or the like. Furthermore, it is simple and convenient to install the system just using separate devices such as a power source, modem or subsystem to distribute communication data. About 85 percent of the world population now uses electricity, while only 12 to 15 percent uses the Internet through the telephone line, high speed communication network or the like. In that regard, without installing another optical communication cable or a coaxial cable, if a data transmission at high speeds is available using the preexisting power line within a ship compartment, economical values of the PLC might be remarkably increased. In addition, with the PLC, it is possible to establish the Internet service and the related networks, to provide a remote control system for the intelligent electronic appliances based on the power line and a variety of electric devices, and further to provide a remote inspection system for utility meters of water, gas, electricity or the like.

Further, the present active emergency control system based on a real time location recognition system and sensor network uses a power source consisting of a main power source and auxiliary power source for the purpose of performing stable operations in an urgent accident situation. The auxiliary power source includes an emergency power source prescribed by SOLAS (Safety of Life at Sea) and a rechargeable battery.

The embodiments set forth hereinabove have been presented for illustrative purpose only and, therefore, the present invention is not limited to these embodiments. It will be understood by those skilled in the art that various changes and modifications may be made without departing from the scope of the invention defined in the claims.

### INDUSTRIAL APPLICABILITY

With a system according to the present invention, it is expected to contribute to control an emergency situation and further protect and save the lives of passengers when a maritime accident occurs in a large structure like a cruise ship having complicated interiors with numerous attendants and passengers. Further, the inventive system can be broadly used as a practical and economical technology in both a shipbuilding or ocean engineering field and an information and telecommunication field since it can be easily reduced into practice by establishing a system and its application through the incorporation with a conventional emergency control system as well as adopting commercialized technology already in use.

1. An active emergency control system based on a real time location recognition system and sensor network capable of guiding passengers to a safe evacuation route from an accident occurring area, controlling access to the accident area, and rescuing the isolated or trapped passengers using a real time location recognition and sensor network technology when an accident such as a fire, flooding, explosion, collapse or overturning occurs in a large structure like a cruise ship having complicated interiors, comprising:
an accident recognition part 10 for realizing the occurrence of an accident and transferring information on an accident situation to an active exit guiding light 40;
a location detection part 20 for detecting the location of passengers and their evacuation situation and transferring information on the location of passengers and their evacuation situation to the active exit guiding light 40, when an accident has occurred;
a central control unit 30 for displaying the information on the accident situation transmitted from the accident recognition part 10, and producing safe evacuation information based on the scenario which has been programmed by the information on the location of the passengers and their evacuation situation transmitted from the location detection part 20; and
the active exit guiding light 40 for displaying a safe evacuation direction and number of passengers remaining at the accident area based on the evacuation information transmitted from the central control unit 30.

2. The system as recited in claim 1, wherein the accident recognition part 10 comprises, an accident measurement part having a plurality of sensors for measuring temperature, humidity or vibration on a real time basis; and an accident evaluation part for collecting and evaluating data measured at the accident measurement part, wherein if it decides the occurrence of the accident, it transmits information regarding the accident to the central control unit 30.

3. The system as recited in claim 2, wherein relatively more accident measurement parts are to be located at the area that is deemed to have a high probability of the accident accordingly.

4. The system as recited in claim 2, wherein the accident evaluation part evaluates whether an accident has occurred on the basis of the accident occurrence index which is prescribed in advance.

5. The system as recited in claim 2, wherein the accident evaluation part provides information on both the location of the accident area and risk factors of that area when transmitting the information regarding the accident to the central control unit 30.

6. The system as recited in claim 1, wherein the location detection part comprises, a RFID tag possessed by an individual passenger; and a plurality of RFID readers which are designed to recognize the RFID tag and transmit the information of the corresponding RFID tag to the central control unit 30.

7. The system as recited in claim 6, wherein the RFID tag is in the form of a bracelet that the passenger wears around his or her wrist.

8. The system as recited in claim 6, wherein the RFID tag includes personal information of the passenger such as his or her name, age, sex or the like.

9. The system as recited in claim 6, wherein the RFID tag readers are installed at every space where passengers are expected to stay.

10. The system as recited in claim 1, wherein the location detection part 20 detects the location of the passengers and their evacuation situation using an infrared or ultrasonic sensor.

11. The system as recited in claim 1, wherein the central control unit 30 displays the accident situation transmitted from the accident recognition part 10 through a console on a real time basis.

12. The system as recited in claim 11, wherein the central control unit 30 is designed to display information on the location of the accident area, risk factors of that area, location of the passengers, and their evacuation situation.

13. The system as recited in claim 1, wherein the active exit guiding light 40 has a function of displaying the sign [symbol] eep out or [symbol] ait, which controls the evacuation of passengers in order to prevent concentration or congestion of evacuees at a particular area.

14. The system as recited in claim 1, wherein the active exit guiding light 40 generates an alarm to warn passengers of the occurrence of an accident.

15. The system as recited in claim 1, wherein the active exit guiding light 40 displays information on the safe direction of evacuation and the number of remaining passengers at the accident area through a visual and aural means.

16. The system as recited in claim 1, wherein the system establishes a stable operating environment using a Power Line Communication (PLC) or LAN (WAN) separately or simultaneously as a telecommunication network.

17. The system as recited in claim 1, wherein the system uses a power source including a main power source and auxiliary power source for the purpose of performing stable operations in an urgent accident situation, and wherein the auxiliary power source uses a power source including an emergency power source prescribed by SOLAS and a rechargeable battery.
